(19) United States
(12) Patent Application Publication
(10) Pub. No.: US 2011/0037703 A1
(43) Pub. Date: Feb. 17, 2011

(54) Multifunction Calculator

(75) Inventor: Deaji Lou, Guangdong (CN)

Correspondence Address: DONGGUAN TAIYO OPTRONICS CO., LTD, BAISHIGANG MANAGEMENT DISTRICT, CHANGPING TOWN DONGGUAN, GUANGDONG, 523559, omitted

(73) Assignee: DONGGUAN TAIYO OPTRONICS CO., LTD, GUANGDONG (CN)

(21) Appl. No.: 12/988,325

(22) PCT Filed: Apr. 1, 2009
(86) PCT No.: PCT/CN2009/071119

§ 371 Date: Oct. 17, 2010

(30) Foreign Application Priority Data
Dec. 18, 2008 (CN) 200810220142.3

(51) Int. Cl. G06F 3/02

(52) U.S. Cl. 345/169

(57) ABSTRACT

The present invention discloses a multi-functional calculator, comprising a main body, a display screen hinged to the main body, and calculating module, power supply module, and key system on the main body; the main body further has a memory unit that stores digital photos, a processor that is connected to the memory unit and is designed to process the digital photos, and an image control module that is connected to the processor and the display screen and is designed to convert the data processed by the processor into images and display the images on the display screen; the main body further has an USB interface and an external storage media interface; compared to existing calculators, the present invention not only has calculation function but also can display the digital photos stored in the main body on the display screen, so that the digital photos can be paged through. The present invention incorporates calculator function and digital photo display function, and thereby effectively enhances the functions of conventional calculator.

### BACKGROUND OF THE INVENTION

The present invention relates to an improvement of calculator, in particular to a multi-functional calculator.

A calculator is a calculating device that supports simple calculations (add, subtract, multiply, and divide) and even scientific calculations. With convenient and quick calculation function, calculators are widely used in our daily life. A conventional calculator usually comprises a box-shaped main body with keys, a display screen hinged to the main body, and calculating module, power supply module, and key system arranged on the main body in sequence; data is inputted with the keys, and the calculation result is displayed on the display screen. In recent years, various calculators were available in the market, and their appearance became more and more fashionable; however, most improvements were made mainly to the appearance of calculator. Most existing calculators are simple in function, which is to say, they only have calculation function, but don't have satisfactory entertainment function.

### BRIEF SUMMARY OF THE INVENTION

The object of the present invention is to provide a multi-functional calculator, which not only has calculation function but also can display digital photos.

The present invention solves the technical problem with the following technical scheme: a multi-functional calculator, comprising a main body, a display screen hinged to the main body, and calculating module, power supply module, and key system on the main body; the main body further has a memory unit that stores digital photos, a processor that is connected to the memory unit and is designed to process the digital photos, and an image control module that is connected to the processor and the display screen and is designed to convert the data processed by the processor into images and display the images on the display screen.

An USB interface is further arranged on the main body. An external storage media interface is further arranged on the main body. The external storage media interface is a SD card interface, MMC card interface, MS card interface, or XD card interface.

The beneficial efficacies of the present invention lie in: compared to existing calculators, the present invention not only has calculation function but also can display the digital photos stored in the main body on the display screen, so that the digital photos can be paged through conveniently. The present invention incorporates calculator function and digital photo display function, and thereby effectively enhances the functions of conventional calculator.

### BRIEF DESCRIPTION OF THE DRAWINGS

Hereunder the present invention will be further detailed in the embodiments, with reference to the accompanying drawings.

FIG. 1 is a structural diagram of the present invention;

FIG. 2 is a functional block diagram of the circuit part of the present invention.

### DETAILED DESCRIPTION OF THE INVENTION

Hereunder the present invention will be further detailed, with reference to the accompanying drawings.

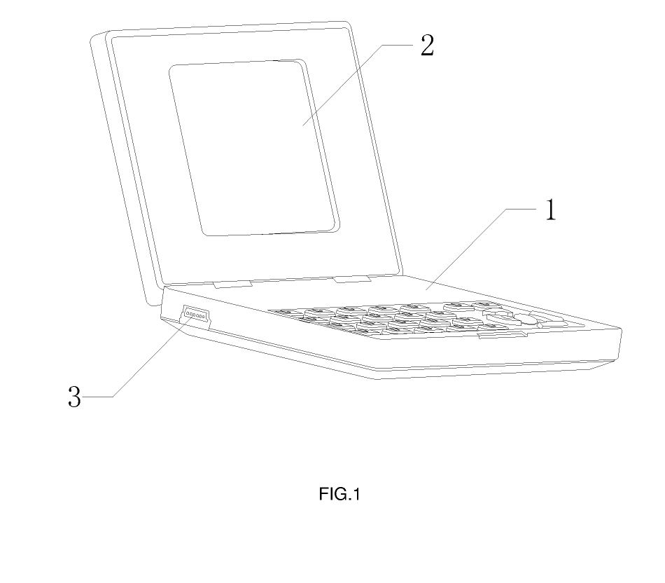

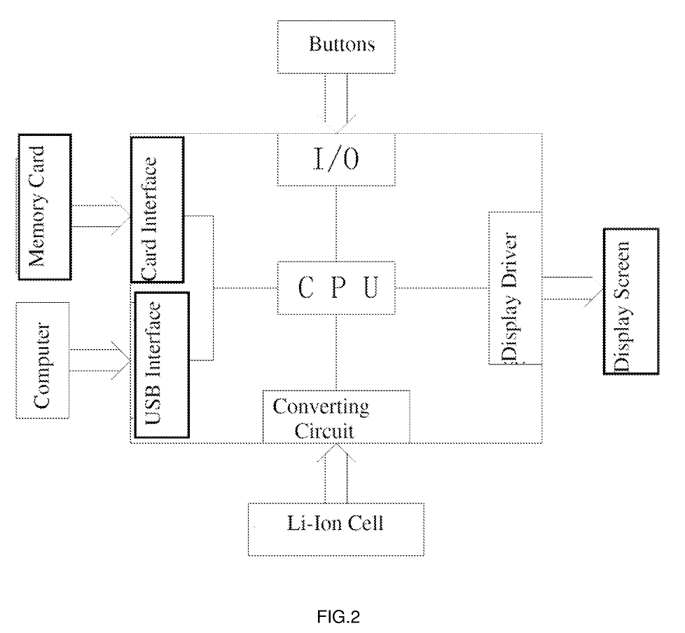

As shown in FIG. 1 and FIG. 2, the present invention provides a multi-functional calculator, comprising a main body 1, a display screen 2 hinged to the main body 1, and calculating module, power supply module, and key system arranged on the main body 1; the main body 1 further has a memory unit designed to store digital photos, a processor connected to the memory unit and designed to decode, zoom in/out, and encode the digital photos stored in the memory unit, and an image control module connected to the processor and the display screen 2 and designed to convert the data processed by the processor into images and display the images on the display screen. Compared to existing calculators, the present invention not only has calculation function but also can display the digital photos stored in the main body on the display screen. The present invention supports paging through the displayed digital photos, and is very practical. The present invention incorporates calculator function and digital photo display function, and thereby effectively enhances the functions of conventional calculator.

Moreover, the main body 1 has an USB interface 3 and an external storage media interface, wherein, the external storage media interface is a SD card interface, MMC card interface, MS card interface, or XD card interface. The USB interface 3 can be connected directly to a computer to transmit the data of digital photos; the storage media interface can receive SD card, MMC card, MS card, or XD card, and supports plug-and-play; once a storage media that stores digital photos is inserted, the corresponding images will be displayed on the display screen.

While the principle and efficacies of the present invention are described and illustrated in above embodiments, the present invention is not limited to these. It is noted that those skilled in the art can make variations and modifications without departing from the spirit of the present invention; however, such variations and modifications shall be deemed as falling into the protected domain of the present invention.

What is claimed is:

1. A multi-functional calculator, comprising a main body (1), a display screen (2) hinged to the main body (1), and calculating module, power supply module, and key system arranged on the main body (1); wherein, the main body (1) further has a memory unit designed to store digital photos, a processor connected to the memory unit and designed to process the digital photos, and an image control module connected to the processor and the display screen (2) and designed to convert the data processed by the processor into images and display the images on the display screen (2).

2. The multi-functional calculator according to claim 1, wherein, the main body (1) further has an USB interface (3).

3. The multi-functional calculator according to claim 1 or 2, wherein, the main body (1) further has an external storage media interface.

4. The multi-functional calculator according to claim 3, wherein, the external storage media interface is a SD card interface, MMC card interface, MS card interface, or XD card interface.
